(19) United States
(12) Patent Application Publication
(10) Pub. No.: US 2024/0394889 A1
(43) Pub. Date: Nov. 28, 2024

(54) INSTANCE-AWARE TRIMAP FOR IMAGE EDITING OPERATIONS

(71) Applicant: Adobe Inc., San Jose, CA (US)

(72) Inventors: He Zhang, Santa Clara, CA (US); Salil Tambe, San Jose, CA (US)

(21) Appl. No.: 18/200,908

(22) Filed: May 23, 2023

(51) Int. Cl. G06T 7/12; G06F 3/04845; G06T 5/50; G06T 7/13; G06V 10/56

(52) U.S. Cl. CPC G06T 7/12; G06F 3/04845; G06T 5/50; G06T 7/13; G06V 10/56; G06T 2207/10024; G06T 2207/20081; G06T 2207/20221

(57) ABSTRACT

An image editing system accesses an input image displayed via a user interface and generates an instance-aware trimap for the input image by applying an instance-aware image segmentation model to input data including the input image and a segmented image defining a segment of the input image including a first set of pixel values. The trimap defines a modified segment using a second set of pixels different from the first set of pixels. Applying the model includes detecting boundaries of an object depicted in the input image. The second set of pixels is located within the boundaries of the object. Responsive to receiving a request via the user interface, the system generates a modified image by performing an editing operation on the input image including editing a portion of the second set of pixels of the modified segment of the trimap. The system transmits, for display, the modified image.

### TECHNICAL FIELD

This disclosure generally relates to techniques for using machine learning models to segment images for use in image editing operations. More specifically, but not by way of limitation, this disclosure relates to generating instance-aware segmentation trimaps for images using an instance-aware trimap model.

### BACKGROUND

Detecting object boundaries in digital images can be a difficult task. Specifically, conventional systems that utilize object detection to generate image masks for various image/object editing operations lack accuracy and efficiency. For example, some existing systems generate trimap segmentations, which segments an image into a foreground, a background, and unknown regions.

### SUMMARY

The present disclosure describes techniques for generating, for an image, an instance-aware trimap using an instance-aware trimap model. An image editing system accesses an input image displayed via a user interface. The image editing system generates an instance-aware trimap for the input image by applying an instance-aware image segmentation model to input data. The input data includes the input image and a segmented image defining a segment of the input image including a first set of pixel values. The instance-aware trimap defines a modified segment using a second set of pixels different from the first set of pixels. Applying the instance-aware image segmentation model includes detecting boundaries of an object depicted in the input image, wherein the second set of pixels is located within the boundaries of the object. Responsive to receiving a request via the user interface, the image editing system generates a modified image by performing an editing operation on the input image by editing at least a portion of the second set of pixels of the modified segment of the instance-aware trimap. The image editing system transmits, for display via a user interface, the modified image.

Various embodiments are described herein, including methods, systems, non-transitory computer-readable storage media storing programs, code, or instructions executable by one or more processing devices, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment for using an instance-aware segmentation model to generate, based on an input image depicting multiple objects of a same type, an instance-aware trimap for use in image editing operations performed on the input image, according to certain embodiments disclosed herein.

FIG. 2 depicts a method to generate, for an image depicting multiple objects of a same type and using an instance-aware trimap model, an instance-aware trimap for use in performing editing operations on the image, according to certain embodiments disclosed herein.

FIG. 3 depicts an instance-aware trimap model, according to certain embodiments disclosed herein.

FIG. 4A depicts a method for training the instance-aware trimap model of FIG. 3 to generate, from an input image that depicts multiple objects of a same type, an instance-aware trimap, according to certain embodiments described herein.

FIG. 4B depicts an illustration of training data generated via the method of FIG. 4A, according to certain embodiments described herein.

FIG. 5 illustrates an example instance-aware trimap generated using the instance-aware trimap model of FIG. 3 compared to a conventionally generated trimap, according to certain embodiments described herein.

FIG. 6 depicts an example of a computing system that performs certain operations described herein, according to certain embodiments disclosed herein.

FIG. 7 depicts an example of a cloud computing system that performs certain operations described herein, according to certain embodiments disclosed herein.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary” or “example” is not necessarily to be construed as preferred or advantageous over other embodiments or designs.

Conventional image segmentation models, for example, conventional trimap models, do not generate useful image segments for images which include multiple instances of similar objects. For example, in an image of two people a conventional image segmentation model generates a single image segment encompassing hair of both of the two people in the image. However, such conventionally generated segments may not be useful for image editing. For example, the user may want to edit the hair for just one of the two people in the image but is unable to do so with the conventionally generated hair segment that encompasses the hair of both people in the image. Thus, conventional image segmentation models are unable to restrict an image segment to a specific instance of multiple similar objects in an image. In other words, conventional image segmentation models are not instance aware.

Certain embodiments described herein address the limitations of conventional scene generating models by providing an instance-aware image segmentation model that is trained to generate an image segment for a single object in an image that includes multiple similar objects. The instance-aware trimap model described herein generates segmented images including segments that are not limited by a boundary of a specific instance of multiple similar objects detected in the image. The segmented images generated using the methods described herein, which include segments encompassing a region of the image that does not exceed a boundary of a detected object in the image, are superior over conventionally segmented images which include segments which do not consider object boundaries in the image when generating segments.

The following non-limiting example is provided to introduce certain embodiments. In this example, an image editing system accesses an image displayed via a user interface. In an example, a user captures the image using a user computing device. In this example, the user accesses an image editing application, selects the image, and the image is displayed on the user interface of the user computing device. The image includes multiple instances of similar objects. In some instances, the multiple instances of similar objects are duplicates of an object in the image. In some instances, the multiple instances of similar objects are two or more objects that are of a similar type. For example, the image displayed on the user interface depicts two people standing next to each other.

The image editing system applies a segmentation model to the image to generate a segmented image including a segment identifying a first set of pixel values. In some instances, the segmented image defines each pixel as associated with one of two values, for example, a foreground or a background. For example, the segmented image comprises a mask. For example, in the image of the two people, the segment defines a region of a first person in the image.

The image editing system applies an instance-aware segmentation model to the segmented image and the input image to generate an instance-aware trimap. In some embodiments, the instance-aware segmentation model comprises a matting model for rendering boundary details for fibrous objects in images (e.g., hair). The instance-aware trimap includes a modified segment determined based on boundaries of an object detected in the image. The modified segment is defined by a second set of pixel values which are different from the first set of pixel values. The modified segment includes the hair of only one of the two people in the image. For example, in the instance-aware trimap each pixel in the image is associated with one of a foreground (corresponding with the region of the modified segment), a background, or an unknown region. In some instances, the modified segment of the instance-aware trimap defines boundaries of the object to a greater degree of accuracy than the segmented image.

The image editing system applies, responsive to receiving a request, an image editing model to the instance-aware trimap to generate a modified image. A set of pixels associated with the second set of pixel values of the modified segment are edited in the modified image. In some instances, the user selects the object in the image associated with the modified segment via the user interface and requests to perform an editing operation on the object. In some instances, the editing operation includes changing a color, a texture, or other feature of the second set of pixels in the modified segment. In some instances, the editing operation performed on the second set of pixels includes removing the object associated with the modified segment from the input image. For example, removing the object can include modifying the second set of pixels to correspond to features of a background of the image. Continuing with the example of the image of the two people, the image editing system receives a request to edit the hair of the first person of the two people that is associated with the modified segment and performs an editing operation with respect to the hair object associated with the modified segment. For example, the image editing system performs one or more editing operations on the second set of pixels corresponding to the modified segment in the instance-aware trimap. For example, the editing operations may include one or more of darkening the hair object, lightening the hair object, otherwise changing a color of at least a portion of the hair object, modifying a textural appearance of the hair object, removing the hair object, duplicating the hair object, moving the hair object to a new position in the image, rotating the hair object, resizing the hair object, or otherwise editing the hair object.

The image editing system displays the modified image via the user interface. For example, responsive to receiving the request to modify the image, the image editing system displays the modified image via the user interface. Continuing with the example of the image of the two people, the image editing system displays the modified image including the hair object edited by the image editing system.

The embodiments described herein, specifically generating an instance-aware trimap model using an instance-aware segmentation model, significantly improves the image segmentation process over conventional segmentation processes. As previously discussed, conventionally generated image segments may not be useful for image editing operations because the conventional image segmentation processes do not consider object boundaries in the image when generating the segments. For example, in an image of two people a conventional image segmentation model may generate a modified image segment encompassing hair of both of the two people in the image. However, such conventionally generated segments may not be useful for image editing. The embodiments described herein address these deficiencies of the conventional segmentation processes by incorporating an instance-aware trimap model that detects objects in images and generates segments that correspond to object boundaries, which are superior to conventionally generated segments that may extend within boundaries of multiple instances of similar objects.

### Example Operating Environment for Generating, Based on an Input Image Depicting Multiple Objects of a Same Type and Using an Instance-Aware Segmentation Model, an Instance-Aware Trimap for Use in Image Editing Operations Performed on the Input Image

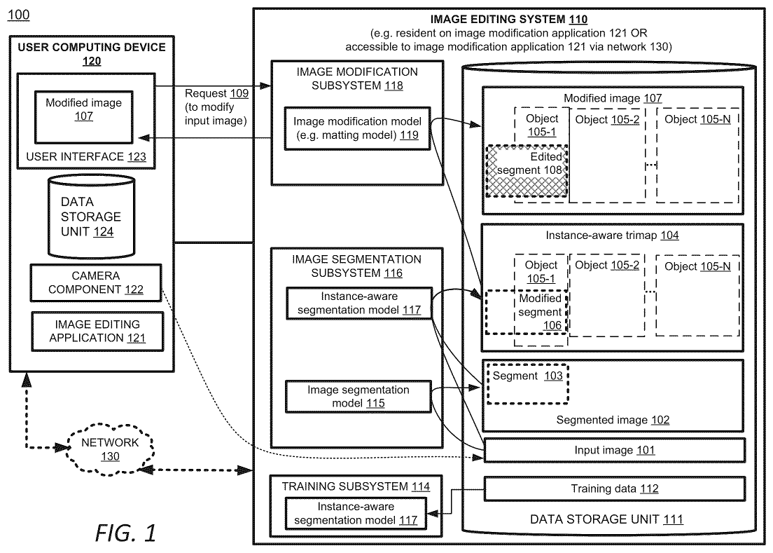

Referring now to the drawings, FIG. 1 depicts an example of a computing environment 100 for using an instance-aware segmentation model 117 to generate, based on an input image 101, an instance-aware trimap 104 for use in image editing operations performed on the input image 101, according to certain embodiments disclosed herein. The computing environment 100 includes, as depicted in FIG. 1, an image editing system 110, which can include one or more processing devices that execute a training subsystem 114, an image segmentation subsystem 116, and an image modification subsystem 118. In certain embodiments, the image editing system 110 is a component of a user computing device 120 and operates on the user computing device 120. In certain embodiments, as also depicted in FIG. 1, the image editing system 110, including the training subsystem 114, the image segmentation subsystem 116, the image modification subsystem 118, and the data storage unit 111, is a network server or other computing device that is accessible to the user computing device 120 and communicates with the user computing device 120 via a network 130.

The image editing system 110 generates an instance-aware trimap for an input image 101. For example, the image segmentation subsystem 116 includes an image segmentation model 115 and an instance-aware segmentation model 117. The image segmentation subsystem 116 generates a segmented image 102 by applying the segmentation model 115 to the input image 101. The segmented image 102 includes at least one segment 103. The image segmentation subsystem 116 generates the instance-aware trimap 104 by applying the instance-aware segmentation model 117 to the segmented image 102 and the input image 101. The instance-aware trimap 104 includes a modified segment 106 that is generated based on boundaries of one of the objects 105 detected in the input image 101 (e.g., object 105-1).

In certain embodiments, the image modification subsystem 118 performs one or more image editing operations on the generated instance-aware trimap 104. In some instances, the image modification subsystem 118 edits an object corresponding to the modified segment 106 in the instance-aware trimap 104. Editing the object corresponding to the modified segment 106 may comprise changing a color of, changing a lighting effect of, changing a texture effect of, changing a position of, rotating, duplicating, removing, resizing, or otherwise modifying the object corresponding to the modified segment 106. In some embodiments, the image modification subsystem 118 accesses an image modification model 119 and modifies the object corresponding to the modified segment 106 by applying the image modification model 119 to the instance-aware trimap 104. For example, the editing operation comprises removing the object and the image modification subsystem 118 determines new pixel values (e.g., color or other values) for pixels corresponding to the modified segment 106 by applying the image modification model 119 to the instance-aware trimap 104. In this example, the new pixel values are such that the object corresponding to the modified segment 106 appears to be removed from the image (e.g., showing only a background in the region of the modified segment 106) in the modified image 107.

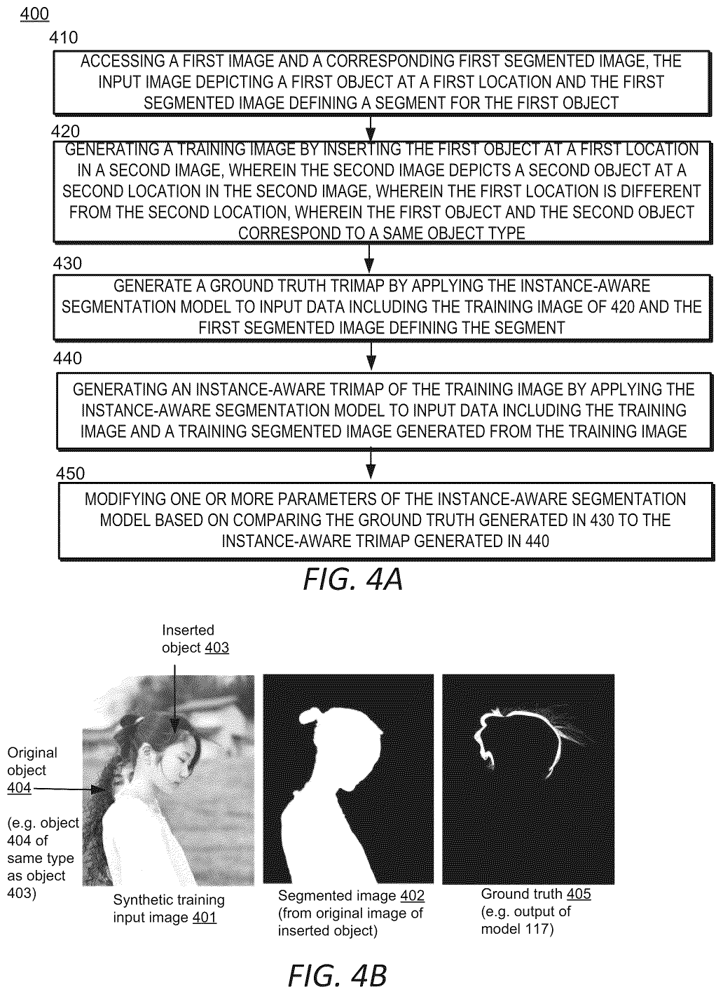

In certain embodiments, the training subsystem 114 trains the instance-aware segmentation model 117 using training data 112 comprising a set of training images. In some instances, the training subsystem 114 generates training images having multiple instances of similar objects to train the instance-aware segmentation model 117 to generate segments in an instance-aware trimap 104 based at least in part on boundaries of objects 105 detected in an input image 101. Further details about training the instance-aware segmentation model 117 are described in FIG. 4.

The image editing system 110 includes a data storage unit 111. An example data storage unit 111 is accessible to the image editing system 110 and stores data for the image editing system 110. In some instances, the data storage unit 111 stores a set of training data 112 for use in training an instance-aware segmentation model 117. In some instances, the data storage unit 111 stores one or more input images 101. In some instances, the data storage unit 111 stores one or more segmented images 102 generated by the image segmentation subsystem 116 using an image segmentation model 115. In some instances, the data storage unit 111 stores one or more instance-aware trimaps 104 generated by the image segmentation subsystem 116 using the instance-aware segmentation model 117. In some instances, the data storage unit 111 stores one or more modified images 107 generated by the image modification subsystem 118 based on one or more instance-aware trimaps 104. In some instances, the data storage unit 111 stores the instance-aware segmentation model 117. In some instances, the data storage unit 111 stores the image segmentation model 115. In some instances, the data storage unit 111 stores the image modification model 119.

An example user computing device 120 includes an image editing application 121, a camera component 122, a user interface 123, and a data storage unit 124. In certain embodiments, the user computing device 120 is a smart phone device, a personal computer (PC), a tablet device, or other user computing device 120. In some embodiments, the user computing device 120, as depicted in FIG. 1, includes the image editing system 110. For example, the training subsystem 114, the image segmentation subsystem 116, and the image modification subsystem 118 are components of the image editing application 121 and the data storage unit 124 performs functions described herein as being performed by the data storage unit 111. However, in other embodiments, as also depicted in FIG. 1, the user computing device 120 is a separate system from the image editing system 110 and communicates with the image editing system 110 via the network 130.

The image editing application 121, in some embodiments, is associated with a scene modeling service and the user downloads the image editing application 121 on the user computing device 120. For example, the user accesses an application store or a website of an image editing service using the user computing device 120 and requests to download the image editing application 121 on the user computing device 120. The image editing application 121 operates on the user computing device 120 and enables a user of the user computing device 120 to generate modified images 107 from an input image 101. The image editing application 121 enables the user to interact, via the user interface 123 with the image editing application 121. The image editing application 121 can communicate with the user interface 123 to receive one or more inputs from the user. The image editing application 121 can instruct the user interface 123 to display the input image 101 and one or more modified images 107 generated based on an instance-aware trimap 104 generated based on the input image 101. In some embodiments, the image editing application 121 communicates with one or more of the training subsystem 114, the image segmentation subsystem 116, and the image modification subsystem 118 of the image editing system 110.

In certain embodiments, the image editing application 121 includes the training subsystem 114, the image segmentation subsystem 116, and the image modification subsystem 118 and performs the operations described herein as being performed by the subsystems 114, 116, and 118. For example, in certain embodiments, the image editing application 121 of the user computing device 120 can generate an instance-aware trimap 104 based on an input image 101 and a segmented image 102 associated with the input image 101 and can generate one or more modified images 107 based on the generated instance-aware trimap 104.

In certain embodiments the camera component 122 is a camera module or camera device component of the user computing device 120 that is able to capture images and/or video of an environment of the camera component 122. In some embodiments, the camera component 122 is a separate device from the user computing device 120 and is communicatively coupled to the user computing device 120. The camera component 122 communicates with the image editing application 121 and transmits, to the image editing application 121, an input image 101 captured by the camera component 122. For example, the input image 101 is of an environment of the user computing device camera component 122. In some instances, however, the input image 101 is not captured by the camera component 122.

The data storage unit 124 is accessible to the user computing device 120 and stores data for the user computing device 120. In some instances, the data storage unit 124 stores an input image 101. In some instances, the data storage unit 124 stores one or more of a segmented image 102, an instance-aware trimap 104, or a modified image 107 generated by the image editing system 110.

The user interface 123 can include a touchscreen display interface, a display device (e.g., a monitor) with a separate input device (e.g., a mouse), or other user interface 123 which can receive one or more inputs from the user and display information or provide other output to the user. For example, the user interface 123 can display an input image 101. In some instances, the user interface 123 displays one or more segments 103 or modified segments 106 generated by the image editing system 110 for the displayed input image 101. For example, the user interface 123 can display a modified segment 106 as a mask. In an example, the user interface 123 can display one or more user interface 123 objects enabling the user to select one or more modified segments 106 (e.g., masks) generated by the image editing system 110 on which to perform editing operations. In this example, the user interface 123 can also display user interface 123 objects corresponding to one or more user interface operations that are selectable by the user. The user interface 123 can display one or more modified images 107 generated by the image editing system 110.

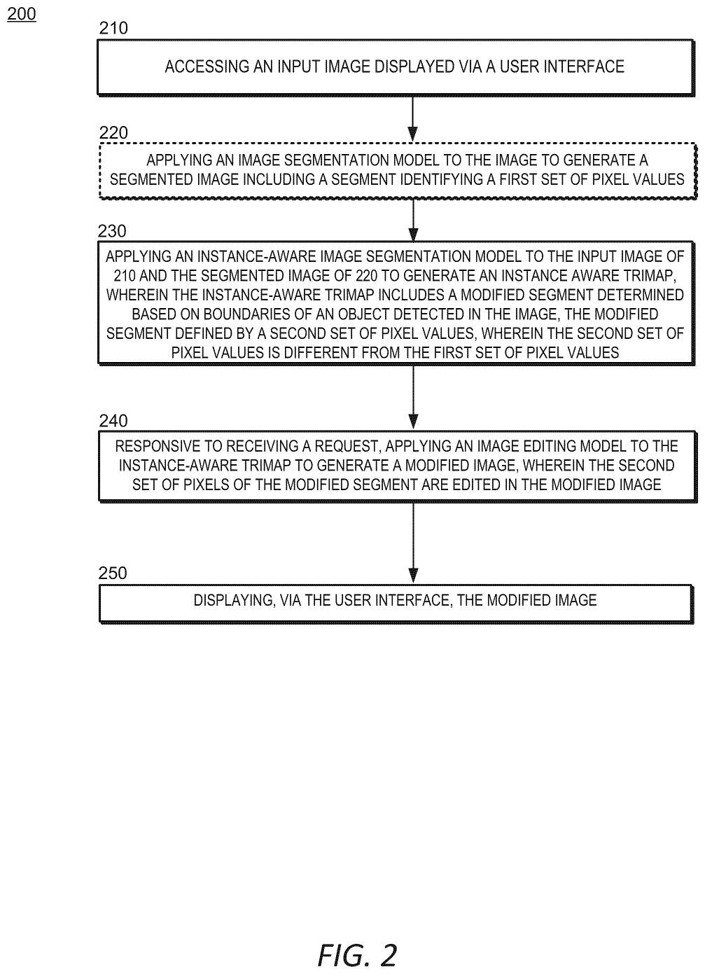

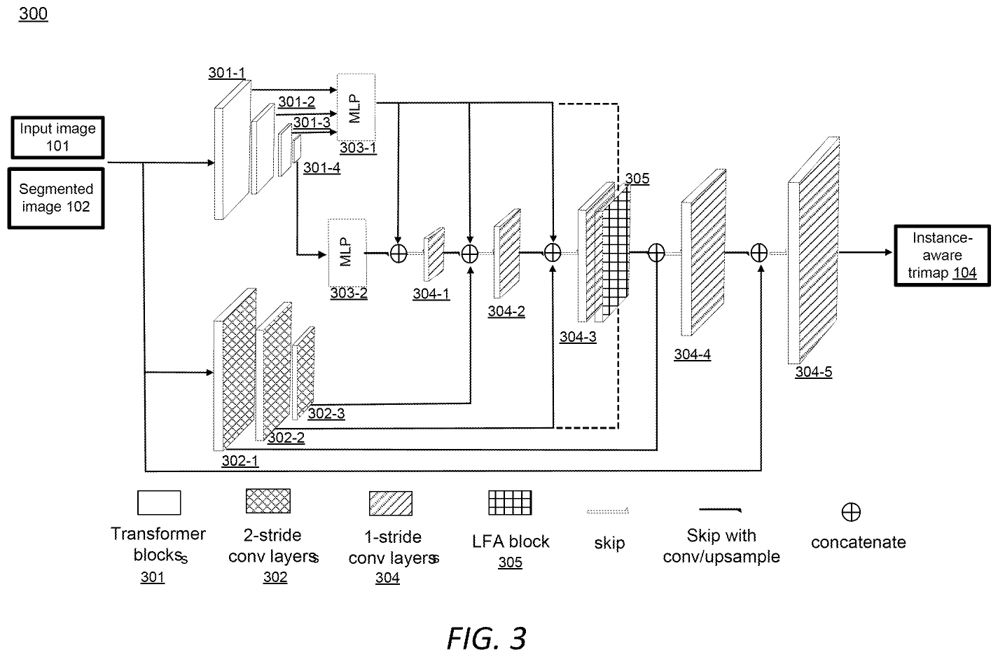

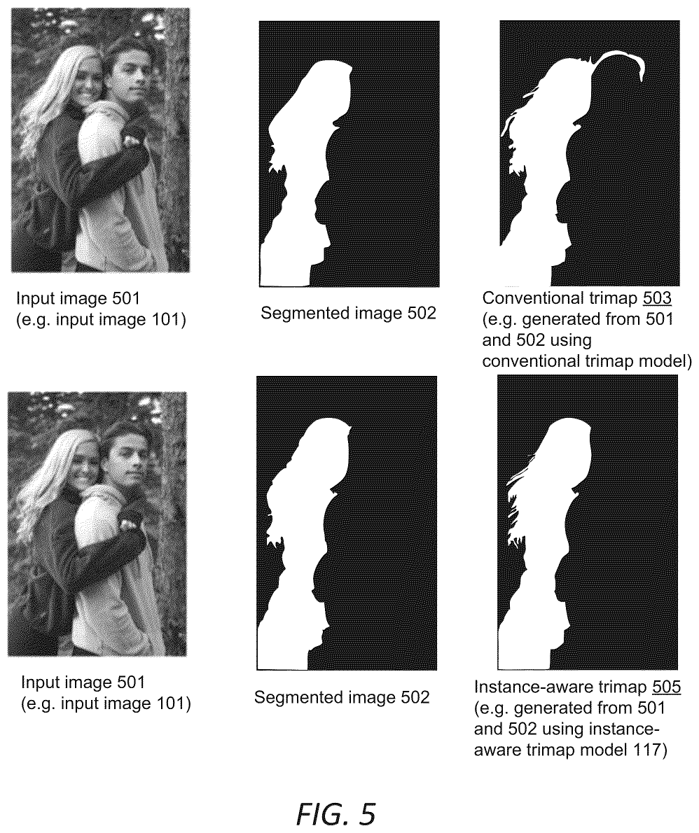

As depicted in FIG. 1, the image editing system 110 can receive an input image 101 of the user computing device 120 and generate modified image 107 responsive to receiving a request 109 via the user interface 123 of the user computing device 120. In some instances, the input image 101 is captured by the camera component 122 of the user computing device 120. In some instances, the training subsystem 114 trains the instance-aware segmentation model 117. Further details about training the instance-aware segmentation model are described herein in FIG. 4. The image editing system 110 can apply an image segmentation model 115 to the input image 101 to generate a segmented image 102. To generate an instance-aware segmentation of the input image 101, the image editing system 110 uses the trained instance-aware segmentation model 117. The inputs to the instance-aware segmentation model 117 comprise the input image 101 and the segmented image 102. The output of the instance-aware segmentation model 117 is the instance-aware trimap 104. Further details about the instance-aware segmentation model 117 are described in FIG. 3. As shown in FIG. 1, the instance-aware segmentation model 117 generates a modified segment 106 that based on boundaries of object 105-1 (and that does not encroach into boundaries of object 105-2). FIG. 5 provides an illustration that compares the outputs (e.g., modified segment 106) of the instance-aware segmentation model 117 described herein to outputs (e.g., segment 103) of an image segmentation model 115. The image editing system 110 can generate a modified image 107 based on the instance-aware trimap 104 responsive to receiving a request 109 of the user via the user interface 123. Further details about generating the instance-aware trimap 104 and generating the modified image 107 are provided herein in FIG. 2.

The image editing system 110, including the training subsystem 114, the image segmentation subsystem 116, and the image modification subsystem 118, may be implemented using software (e.g., code, instructions, program) executed by one or more processing devices (e.g., processors, cores), hardware, or combinations thereof. The software may be stored on a non-transitory storage medium (e.g., on a memory component). The computing environment 100 depicted in FIG. 1 is merely an example and is not intended to unduly limit the scope of claimed embodiments. One of ordinary skill in the art would recognize many possible variations, alternatives, and modifications. For example, in some implementations, the image editing system 110 can be implemented using more or fewer systems or subsystems than those shown in FIG. 1, may combine two or more subsystems, or may have a different configuration or arrangement of the systems or subsystems.

### Examples of Computer-Implemented Operations for Generating, Based on an Input Image Depicting Multiple Objects of a Same Type and Using an Instance-Aware Segmentation Model, an Instance-Aware Trimap for Use in Image Editing Operations

In the embodiments described herein, the image editing system 110 can generate an instance-aware trimap 104 by applying an instance-aware image segmentation model 117 to input data including an input image 101 and a segmented image 102 generated using an image segmentation model 115. The instance-aware trimap 104 can be used to generate one or more modified images 107. Modified segments 106 generated using the instance-aware image segmentation model 117 (e.g., modified segments 106 as illustrated in FIG. 1) are generated based on boundaries of objects 105 detected in the input image 101 by the instance-aware image segmentation model 117. FIG. 2 provides further details about generating the instance-aware trimap 104 from an input image 101 and generating a modified image 107 based on the instance-aware trimap 104. FIG. 3 provides further details describing the instance-aware image segmentation model 117. FIG. 4 provides further details about training the instance-aware image segmentation model 117. FIG. 5 illustrates a comparison between segmented images 102 generated using an image segmentation model 115 and instance-aware trimaps 104 generated using an instance-aware image segmentation model 117.

FIG. 2 depicts an example of a method for generating, based on an input image 101 depicting multiple objects of a same type and using an instance-aware segmentation model 117, an instance-aware trimap 104 for use in image editing operations, according to certain embodiments disclosed herein. One or more computing devices (e.g., the image editing system 110 or the individual subsystems contained therein) implement operations depicted in FIG. 2. For illustrative purposes, the method 200 is described with reference to certain examples depicted in the figures. Other implementations, however, are possible.

In certain embodiments described herein, the image editing system 110 is a component of the user computing device 120 and the operations described herein as performed by the image editing system 110 (or one or more of the subsystems 114, 116, or 118 thereof) are performed by the image editing application 121 of the user computing device 120. However, in some embodiments, the image editing system 110 is separate from the user computing device 120 and communicates with the user computing device 120 via the network 130. In some embodiments, the image editing system 110 is separate from the user computing device 120 but one or more operations described herein as performed by the image editing system 110 (or one or more subsystems 114, 116, or 118 thereof) are performed by the image editing application 121 of the user computing device 120.

At block 210, the method 200 involves accessing an input image 101 displayed via a user interface 123. In an example, a user of the user computing device 120 captures the image using the user computing device 120. In this example, the user accesses an image editing application 121, selects the input image 101, and the input image 101 is displayed on the user interface 123 of the user computing device. The input image 101 includes multiple instances of similar objects 105. In some instances, the multiple instances of similar objects 105 are duplicates of an object 105 in the image. In some instances, the multiple instances of similar objects 105 are two or more objects that are of a similar type. For example, the input image 101 displayed on the user interface 123 depicts two people standing next to each other, where the hair of the first user is within a proximity to the hair of the second user. In another example, the input image 101 displayed on the user interface 123 depicts two people standing next to each other, where the hair, sweater, fur coat, or other item of a hair-like texture of the first user is within a proximity to the hair, sweater, fur coat, or other item of a hair-like texture of the second user. FIG. 5 includes an example of an input image 101 (see input image 501 of FIG. 5).

At block 220, the method 200 involves applying, by an image segmentation subsystem 116, an image segmentation model 115 to an input image 101 to generate a segmented image 102 including a segment 103 defined by a first set of pixel values in the segmented image 102. For example, the segmented image 102 comprises a trimap that specifies, for each pixel in the segmented image 102, one of a foreground pixel value (e.g., corresponding to the segment 103), a background pixel value, or an unknown pixel value. In another example, the segmented image 102 specifies, for each pixel in the segmented image 102, one of a foreground pixel value (e.g., corresponding to the segment 103) or a background pixel value. In the segmented image 102, the first set of pixel values defined by the segment 103 are associated with a first object 105 in the input image 101 of multiple similar objects 105. For example, in the input image of the two people (see input image 501 depicted in FIG. 5), the segment 103 defines pixels corresponding to the first person of the two people depicted in the input image 101.

At block 230, the method 200 involves applying, by the image segmentation subsystem 116, an instance-aware segmentation model 117 to the input image 101 accessed in block 210 and the segmented image 102 generated at block 220 to generate an instance-aware trimap, wherein the instance-aware trimap 104 includes a modified segment 106 determined based on boundaries of an object 105 detected in the image, the modified segment 106 defined by a second set of pixel values, wherein the second set of pixel values are different from the first set of pixel values associated with the segment 103. For example, the input to the instance-aware segmentation model 117 includes both the input image 101 and the segmented image 102. The output of the instance-aware segmentation model 117 is the instance-aware trimap 104. An illustration of the instance-aware trimap 104 is depicted in FIG. 5. Further details about the instance-aware segmentation model 117 are described in FIG. 3.

At block 230, the method 200 involves applying, by the image modification subsystem 118, an image editing model to the instance-aware trimap 104 to generate a modified image 107, wherein one or more of the second set of pixels are edited in the modified image 107. In some instances, at least a portion of the second set of pixels of the modified segment 106 are edited in the modified image 107 when compared to the original input image 101. In some instances, the user selects the modified segment 106 via the user interface and requests to perform an editing operation on a feature of the input image 101 associated with the modified segment 106. In some instances, the editing operation includes changing a color, a texture, or other feature of the second set of pixels of the modified segment 106. In some instances, the editing operation performed on the second set of pixels includes removing the feature associated with the modified segment from the input image 101. For example, removing the object can include modifying the second set of pixel values to correspond to features of a background of the input image 101. Continuing with the example of the input image 101 of the two people (e.g. the input image 501 depicted in FIG. 5), the image modification subsystem 118 receives a request to edit the hair of the first person of the two people that is associated with the modified segment 106 of the instance-aware trimap 104 and performs an editing operation with respect to the hair object associated with the modified segment 106. For example, the image modification subsystem 118 performs one or more editing operations on the second set of pixels corresponding to the modified segment 106 of the instance-aware trimap 104. For example, the editing operations may include one or more of darkening the hair object, lightening the hair object, otherwise changing a color of at least a portion of the hair object, modifying a textural appearance of the hair object, removing the hair object, duplicating the hair object, moving the hair object to a new position in the image, rotating the hair object, resizing the hair object, or otherwise editing the hair object. In some instances, performing the editing operation comprises applying the image modification model 119 to the instance-aware trimap 104. For example, in an image editing operation to remove the hair of the first person associated with the modified segment 106, the image modification model 119 predicts one or more pixel values (e.g., color, etc.) for each of the pixels of the modified segment 106 so that the pixels have an appearance of a background of the input image 101.

At block 240, the method 200 involves displaying, by the image modification subsystem 118 via a user interface 123, the modified image 107 For example, the image modification subsystem 118 displays the modified image 107 via the user interface 123. For example, responsive to receiving the request 109 to modify the input image 101, the image modification subsystem 118 displays the modified image 107 via the user interface 123. Continuing with the example of the input image 101 of the two people, the image modification subsystem 118 displays the modified image 107 including the hair edited by the editing operations performed by the image modification subsystem 118.

FIG. 3 depicts an example instance-aware image segmentation model 117. As depicted in FIG. 3, the inputs to the instance-aware image segmentation model 117 include the input image 101 and the segmented image 102. The input image 101 includes, for each pixel of the input image 101, a red-green-blue (RGB) color value. The segmented image 102 includes, in some instances, a trimap that defines a segment 103 in the input image 101 including, for each pixel value, one of a foreground value, a background value, or an unknown value. The segmented image 102 includes, in some instances, a segment 103 defining, for each pixel value, one of a foreground value or a background value. The output of the instance-aware image segmentation model 117 is the instance-aware trimap 104, which includes, for each pixel, one of a foreground value, a background value, or an unknown value. For example, the instance-aware trimap 104 identifies each pixel as being part of a foreground, a background, or an unknown area.

As depicted in FIG. 3, an encoder of the instance-aware image segmentation model 117 comprises a two-branch network, where a transformer-based branch includes a set of transformer blocks 301 (e.g., transformers 301-1, 301-2, 301-3, and 301-4) and a convolution-based branch includes a set of 2-stride convolutional layers 302 (e.g. convolutional layers 302-1, 302-2, and 302-3). The transformer-based branch models a global context and the convolution-based branch supplements low-level information for details. In the example depicted in FIG. 3, the instance-aware image segmentation model 117 leverages a 32-stride pyramid vision transformer backbone to obtain hierarchical features. Because trimap models (e.g., matting models) do interference with various original input resolutions, a fixed position embedding is not used and overlapped convolutions are used instead of a fixed position embedding. In some instances, due to a large capacity of transformer blocks 301 in the instance-aware image segmentation model 117, only 2-stride convolution layers 302 are used in the convolution-based branch to form 8-stride. In some instances, the instance-aware image segmentation model 117 utilizes two small backbones (e.g., mit-b1 and mit-b2), as shown in FIG. 3, because of limited training data. Further, the instance-aware image segmentation model 117 uses two encoder architectures with different capacities (e.g., E1, E2). In the instance-aware image segmentation model 117, as a bridge to recover resolutions and capture details, a decoder includes MLP layers 303 (e.g., MLP layers 303-1 and 303-2) and 2-stride convolution layers 302 (e.g. 2-stride convolution layers 302-1, 302-2, 302-3).

In the instance-aware image segmentation model 117 depicted in FIG. 3, feature maps with different resolutions are skipped from the transformer branch of the encoder (e.g., TSkip) to the decoder after the MLP layers 303/convolution layers 304. The feature maps transport global information while recovering a resolution. In some instances, the transformer branch starts from a quarter (¼) resolution and therefore details may be missing at the initial downsampling stage. Accordingly, another source of skip information learned in the convolution branch (LSkip) of the instance-aware image segmentation model 117 can also be used.

The example instance-aware image segmentation model 117 depicted in FIG. 3 assembles low-level features using a transformer block. For example, a self-attention operation in the transformer blocks 301 (e.g., which can be represented as Attn(Q,K,V)) denotes a self-attention operation in the transformer block. In this example, a feature fusion attention can be used and can be represented as Attn(f_{low}, f_{low}, f_{d}), where f_{low} represents the skipped feature from the encoder and f_{d} is the feature in the decoder to be refined. In the example depicted in FIG. 3, only one LFA block 305 is added after the one quarter (¼) resolution decoder layer, to restrict computation. In some instances, including the LFA block 305 in the instance-aware image segmentation model 117 improves an accuracy of the generated instance-aware trimap 104.

FIG. 4A depicts an example of a method for training an instance-aware segmentation model 117 to generate instance-aware trimaps 104 from input images 101 that depict multiple objects of a same type, according to certain embodiments disclosed herein. One or more computing devices (e.g., the training subsystem 114) implement operations depicted in FIG. 4A. For illustrative purposes, the method 400 is described with reference to certain examples depicted in the figures. Other implementations, however, are possible.

At block 410, the method 400 involves accessing, by the training subsystem 114) a first input image 101 and a corresponding first segmented image 102, the first input image 101 depicting a first object at a first location and the first segmented image 102 defining a segment for the first object. For example, the first segmented image 102 comprises a trimap defining a mask for the first object. In some embodiments, the image editing system 110 may generate the first segmented image 102 by applying the image segmentation model 115 to the first input image 101. In other embodiments, the first segmented image 102 does not generate the first segmented image 102 and merely retrieves a stored, pre-segmented, first segmented image 102 associated with the first input image 101. In an example, the first object is a first person depicted in the first input image 101.

At block 420, the method 400 involves generating, by the training subsystem 114, a training image by inserting the first object at a first location in a second image, wherein the second image depicts a second object in a second location in the second image, wherein the first location is different from the second location, wherein the first object and the second object correspond to a same object type. For example, the second object is a second person depicted in the second image. In some instances, the training subsystem 114 inserts the first object into a foreground at the first location. In some instances, the inserted first object overlaps with a portion of the second object.

At block 430, the method 400 involves generating a ground truth trimap by applying the instance-aware image segmentation model 117 to input data that includes the training image generated in block 420 and the first segmented image 102 defining the segment for the first object. Details describing applying the instance-aware image segmentation model 117 to the input data are described in FIG. 2 (e.g., block 230) and FIG. 3. An illustration of a ground truth trimap is depicted in FIG. 5.

At block 440, the method 400 involves generating an instance-aware trimap 104 of the training image by applying the instance-aware image segmentation model 117 to input data that includes the training image generated in block 420 and a training segmented image generated from the training image. For example, the training subsystem 114 generates the training segmented image by applying the image segmentation model 115 to the training image generated in block 420. The training subsystem 114 applies the instance-aware image segmentation model 117 to the training image generated in block 420 and the training segmented image generated from the training image.

At block 450, the method 400 involves modifying one or more parameters of the instance-aware image segmentation model 117 based on comparing the ground truth trimap generated in block 430 to the instance-aware trimap generated in block 440. For example, the training subsystem 114 modifies parameters of one or more of the transformer blocks 301, the 2-stride convolutional layers 302, the MLPs 303, the 1-stride convolutional layers 304, or the LFA block 305.

FIG. 4B depicts an illustration of training data generated via the method of FIG. 4A, according to certain embodiments described herein. For illustrative purposes, FIG. 4B is described with reference to certain examples depicted in the figures. Other implementations, however, are possible. FIG. 4B depicts an example synthetic training image 401. For example, the synthetic training image 401 can be generated using the method described in block 420 of FIG. 4A. For example, the synthetic training image 401 includes an inserted object 403 that is inserted into a foreground of an image depicting original object 404. Both the inserted object 403 and the original object 404 are of a same object type (e.g., object type “woman”).

FIG. 4B also depicts a segmented image 402, which is a segmented image corresponding to the source image of the inserted object 403 and which defines a segment for the inserted object 403. In some instances, the training subsystem 114 generates the segmented image 402 from the source image of the inserted object 403 using the image segmentation model 115. In some instances, the training subsystem 114 does not generate the segmented image 402 and retrieves the segmented image 402, which is associated with the source image of the inserted object 403, from the data storage unit 124. The training subsystem 114 generates the ground truth trimap 405 by applying the instance-aware image segmentation model 117 to the input data including the synthetic input image 401 and the segmented image 402. For example, the ground truth trimap 405 can be generated using the method described in FIG. 430 of FIG. 4A.

FIG. 5 illustrates an example instance-aware trimap generated using the instance-aware trimap model of FIG. 3 compared to a conventionally generated trimap, according to certain embodiments described herein. For illustrative purposes, FIG. 5 is described with reference to certain examples depicted in the figures. Other implementations, however, are possible. As illustrated in FIG. 5, a conventional trimap 503 can be generated from an input image 501 and a segmented image 502 (e.g., mask) generated from the input image 501 using a conventional trimap model. However, as shown in FIG. 5, such conventional trimaps 503 are inaccurate and not useful because the boundaries, as illustrated in FIG. 5, of the segment (represented by the white region of the image) do not respect boundaries of objects in the input image 501. As can be seen in FIG. 5, the hair component of the segment in the conventional trimap 503 not only includes hair from a first object in the image (e.g., the woman standing behind the man) but also includes a portion of hair from a second object in the input image 501 (e.g., the man standing to the right of the woman).

FIG. 5 also illustrates an instance-aware trimap 104 can be generated from the same input image 501 and segmented image 502 (e.g., mask) generated from the input image 501 using the instance-aware image segmentation model 117 described herein. As shown in FIG. 5, the segment (represented by the white region of the image) of the instance-aware trimap 505 respects boundaries of objects in the input image 501. As can be seen in FIG. 5, the hair component of the segment in the instance-aware trimap 505 is limited by boundaries of the first object in the input image 501 (e.g., the woman) does not intrude on boundaries of the second object in the segmented image 502 (e.g., the man). Accordingly, the segment depicted in the instance-aware trimap 505 does not include any hair from the man depicted in the image. This instance-aware trimap 505 is more useful for image editing operations than the conventional trimap as it is likely that a user may request to edit the hair of the woman in the image but is unlikely to request to edit the hair of the woman in the image plus the portion of the hair of the man in the image as one single entity.

### Examples of Computing Environments for Implementing Certain Embodiments

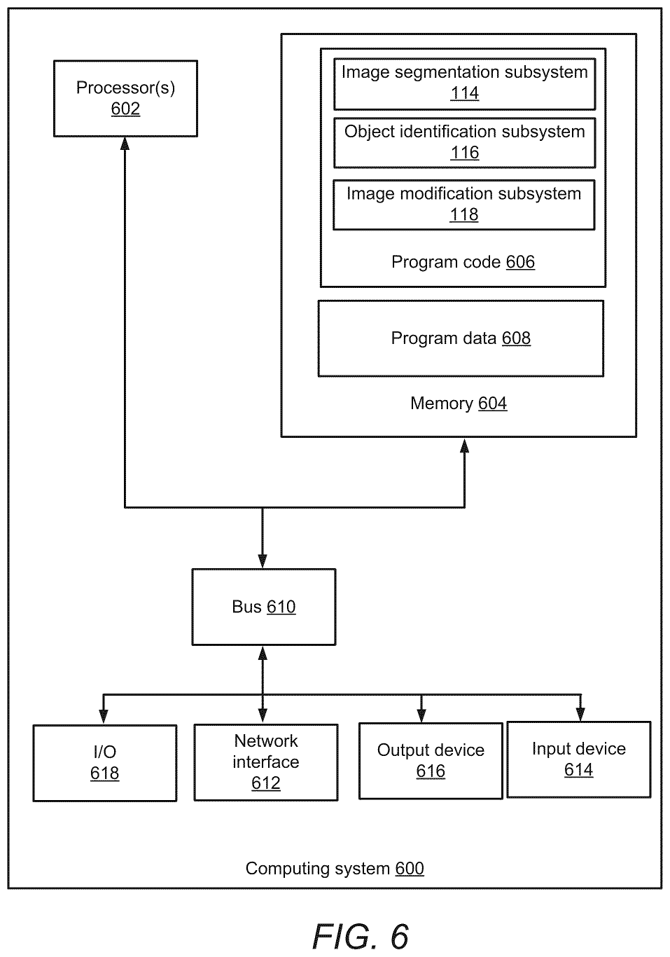

Any suitable computer system or group of computer systems can be used for performing the operations described herein. For example, FIG. 6 depicts an example of a computer system 600. The depicted example of the computer system 600 includes a processing device 602 communicatively coupled to one or more memory components 604. The processing device 602 executes computer-executable program code stored in a memory component 604, accesses information stored in the memory component 604, or both. Execution of the computer-executable program code causes the processing device to perform the operations described herein. Examples of the processing device 602 include a microprocessor, an application-specific integrated circuit (“ASIC”), a field-programmable gate array (“FPGA”), or any other suitable processing device. The processing device 602 can include any number of processing devices, including a single processing device.

The memory components 604 includes any suitable non-transitory computer-readable medium for storing program code 606, program data 608, or both. A computer-readable medium can include any electronic, optical, magnetic, or other storage device capable of providing a processing device with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the memory components 504 can be volatile memory, non-volatile memory, or a combination thereof.

The computer system 600 executes program code 606 that configures the processing device 602 to perform one or more of the operations described herein. Examples of the program code 606 include, in various embodiments, the image editing system 110 (including the training subsystem 114, the image segmentation subsystem 116, and the image modification subsystem 118) of FIG. 1, which may include any other suitable systems or subsystems that perform one or more operations described herein (e.g., one or more neural networks, encoders, attention propagation subsystem and segmentation subsystem). The program code 606 may be resident in the memory components 604 or any suitable computer-readable medium and may be executed by the processing device 602 or any other suitable processor.

The processing device 602 is an integrated circuit device that can execute the program code 606. The program code 606 can be for executing an operating system, an application system or subsystem, or both. When executed by the processing device 602, the instructions cause the processing device 602 to perform operations of the program code 606. When being executed by the processing device 602, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory components 604 store the program data 808 that includes one or more datasets described herein. In some embodiments, one or more of data sets are stored in the same memory component (e.g., one of the memory components 604). In additional or alternative embodiments, one or more of the programs, data sets, models, and functions described herein are stored in different memory components 604 accessible via a data network. One or more buses 610 are also included in the computer system 600. The buses 610 communicatively couple one or more components of a respective one of the computer system 600.

In some embodiments, the computer system 600 also includes a network interface device 612. The network interface device 612 includes any device or group of devices suitable for establishing a wired or wireless data connection to one or more data networks. Non-limiting examples of the network interface device 612 include an Ethernet network adapter, a modem, and/or the like. The computer system 600 is able to communicate with one or more other computing devices via a data network using the network interface device 612.

The computer system 600 may also include a number of external or internal devices, an input device 614, a presentation device 616, or other input or output devices. For example, the computer system 600 is shown with one or more input/output (“I/O”) interfaces 618. An I/O interface 618 can receive input from input devices or provide output to output devices. An input device 614 can include any device or group of devices suitable for receiving visual, auditory, or other suitable input that controls or affects the operations of the processing device 602. Non-limiting examples of the input device 614 include a touchscreen, a mouse, a keyboard, a microphone, a separate mobile computing device, etc. A presentation device 616 can include any device or group of devices suitable for providing visual, auditory, or other suitable sensory output. Non-limiting examples of the presentation device 616 include a touchscreen, a monitor, a speaker, a separate mobile computing device, etc.

Although FIG. 6 depicts the input device 614 and the presentation device 616 as being local to the computer system 600, other implementations are possible. For instance, in some embodiments, one or more of the input device 614 and the presentation device 616 can include a remote client-computing device that communicates with computing system 600 via the network interface device 612 using one or more data networks described herein.

Embodiments may comprise a computer program that embodies the functions described and illustrated herein, wherein the computer program is implemented in a computer system that comprises instructions stored in a machine-readable medium and a processing device that executes the instructions to perform applicable operations. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computer systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

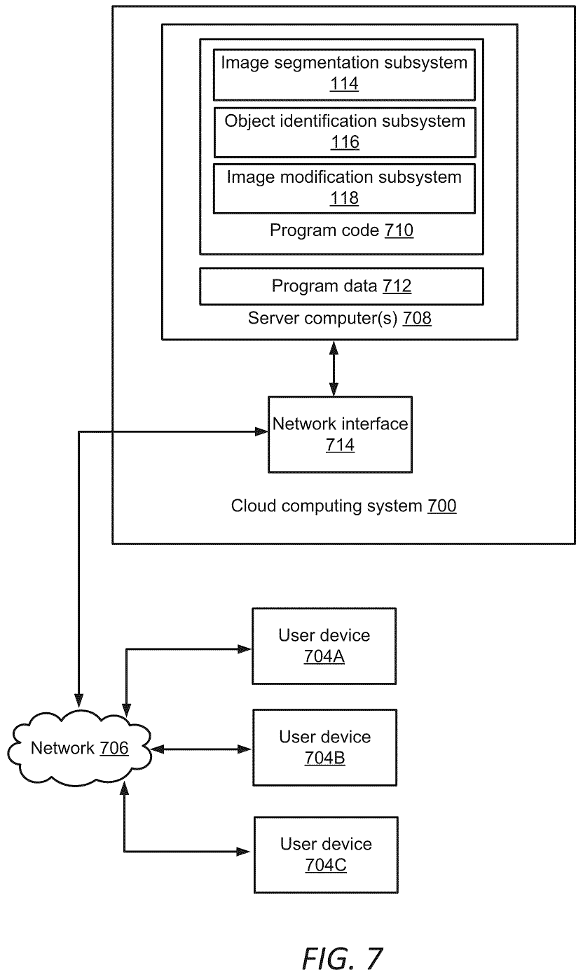

In some embodiments, the functionality provided by computer system 600 may be offered as cloud services by a cloud service provider. For example, FIG. 7 depicts an example of a cloud computer system 700 offering a service for generating an instance-aware trimap 104 for an input image 101, which can be used by a number of user subscribers using user devices 704A, 704B, and 704C across a data network 706. The cloud computer system 700 performs the processing to provide the service of generating an instance-aware trimap 104 for an input image 101. The cloud computer system 700 may include one or more remote server computers 708.

The remote server computers 708 include any suitable non-transitory computer-readable medium for storing program code 710 (e.g., the training subsystem 114, the image segmentation subsystem 116, and the image modification subsystem 118 of FIG. 1) and program data 712, or both, which is used by the cloud computer system 700 for providing the cloud services. A computer-readable medium can include any electronic, optical, magnetic, or other storage device capable of providing a processing device with executable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computers 908 can include volatile memory, non-volatile memory, or a combination thereof.

One or more of the server computers 708 execute the program code 710 that configures one or more processing devices of the server computers 708 to perform one or more of the operations that generate instance-aware trimaps 104 based on input images 101. As depicted in the embodiment in FIG. 7, the one or more servers providing the service for generating an instance-aware trimap 104 based on an input image 101 may implement the training subsystem 114, the image segmentation subsystem 116, and the image modification subsystem 11. Any other suitable systems or subsystems that perform one or more operations described herein (e.g., one or more development systems for configuring an interactive user interface) can also be implemented by the cloud computer system 700.

In certain embodiments, the cloud computer system 700 may implement the services by executing program code and/or using program data 712, which may be resident in a memory component of the server computers 708 or any suitable computer-readable medium and may be executed by the processing devices of the server computers 708 or any other suitable processing device.

In some embodiments, the program data 712 includes one or more datasets and models described herein. In some embodiments, one or more of data sets, models, and functions are stored in the same memory component. In additional or alternative embodiments, one or more of the programs, data sets, models, and functions described herein are stored in different memory components accessible via the data network 706.

The cloud computer system 700 also includes a network interface device 714 that enable communications to and from cloud computer system 700. In certain embodiments, the network interface device 714 includes any device or group of devices suitable for establishing a wired or wireless data connection to the data networks 706. Non-limiting examples of the network interface device 714 include an Ethernet network adapter, a modem, and/or the like. The service for generating an instance-aware trimap 104 based on an input image 101 is able to communicate with the user devices 704A, 704B, and 704C via the data network 706 using the network interface device 714.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

### GENERAL CONSIDERATIONS

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computer system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Additionally, the use of “based on” is meant to be open and inclusive, in that, a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method performed by one or more computing devices associated with a scene modeling system, comprising:
by an image editing system
accessing an input image displayed via a user interface;
generating an instance-aware trimap for the input image by applying an instance-aware image segmentation model to input data comprising (1) the input image and (2) a segmented image defining a segment of the input image including a first set of pixel values, wherein the instance-aware trimap defines a modified segment using a second set of pixels different from the first set of pixels, wherein applying the instance-aware image segmentation model comprises:
detecting boundaries of an object depicted in the input image, wherein the second set of pixels is located within the boundaries of the object;
responsive to receiving a request via the user interface, generating a modified image by performing an editing operation on the input image by editing at least a portion of the second set of pixels of the modified segment of the instance-aware trimap; and
transmitting, for display via a user interface, the modified image.

2. The method of claim 1, further comprising training the instance-aware image segmentation model, wherein training the instance-aware image segmentation comprises:
generating a training image by inserting a first object extracted from a first image into a second image depicting a second object;
applying the instance-aware segmentation model to the training image and a segmented image corresponding to the first image to generate a ground truth trimap;
generating a training segmented image by applying an image segmentation model to the training image;
generating a training instance-aware trimap by applying the instance-aware segmentation model to training input data comprising the training image and the training segmented image;
training the instance-aware image segmentation model by modifying one or more parameters of the instance-aware segmentation model based on comparing the training instance-aware trimap to the ground truth trimap,
wherein applying the instance-aware image segmentation model to the input data comprises applying the trained instance-aware image segmentation model to the input data.

3. The method of claim 1, wherein the image editing operation comprises changing color values of one or more of the second set of pixels.

4. The method of claim 1, wherein the image editing operation comprises applying an object removal model to the instance-aware trimap to replace color values of the second set of pixels with color values approximating a background of the input image.

5. The method of claim 1, further comprising generating, by the image editing system, the segmented image by applying an image segmentation model to the input image.

6. The method of claim 1, wherein the instance-aware image segmentation model comprises a matting model, wherein the modified segment defines a boundary of a fibrous object in the input image.

7. The method of claim 6, wherein the fibrous object comprises hair.

8. A system comprising:
a memory component; and
a processing device coupled to the memory component, the processing device to perform operations comprising:
accessing an input image;
generating an instance-aware trimap for the input image by applying an instance-aware image segmentation model to input data comprising (1) the input image and (2) a segmented image defining a segment of the input image including a first set of pixel values, wherein the instance-aware trimap defines a modified segment using a second set of pixels different from the first set of pixels, wherein applying the instance-aware image segmentation model comprises:
detecting boundaries of an object depicted in the input image, wherein the second set of pixels is located within the boundaries of the object; and
generating a modified image by performing an editing operation on the input image by editing at least a portion of the second set of pixels of the modified segment of the instance-aware trimap;
transmitting, for display via a user interface, the modified image.

9. The system of claim 8, the operations further comprising training the instance-aware image segmentation model, wherein training the instance-aware image segmentation comprises:
generating a training image by inserting a first object extracted from a first image into a second image depicting a second object;
applying the instance-aware segmentation model to the training image and a segmented image corresponding to the first image to generate a ground truth trimap;
generating a training segmented image by applying an image segmentation model to the training image;
generating a training instance-aware trimap by applying the instance-aware segmentation model to training input data comprising the training image and the training segmented image;
training the instance-aware image segmentation model by modifying one or more parameters of the instance-aware segmentation model based on comparing the training instance-aware trimap to the ground truth trimap,
wherein applying the instance-aware image segmentation model to the input data comprises applying the trained instance-aware image segmentation model to the input data.

10. The system of claim 8, wherein the image editing operation comprises changing color values of one or more of the second set of pixels.

11. The system of claim 8, wherein the image editing operation comprises applying an object removal model to the instance-aware trimap to replace color values of the second set of pixels with color values approximating a background of the input image.

12. The system of claim 8, the operations further comprising generating, by the image editing system, the segmented image by applying an image segmentation model to the input image.

13. The system of claim 8, wherein the instance-aware image segmentation model comprises a matting model, wherein the modified segment defines a boundary of a fibrous object in the input image.

14. The system of claim 8, wherein the fibrous object comprises hair.

15. A non-transitory computer-readable medium storing executable instructions, which when executed by a processing device, cause the processing device to perform operations comprising:
accessing an input image;
generating a segmented image by applying an image segmentation model to the input image, a segment of the segmented image defining a first set of pixel values;
generating an instance-aware trimap for the input image by applying an instance-aware image segmentation model to input data comprising (1) the input image and (2) the segmented image, wherein the instance-aware trimap defines a modified segment using a second set of pixels different from the first set of pixels, wherein applying the instance-aware image segmentation model includes:
detecting boundaries of an object depicted in the input image, wherein the second set of pixels is located within the boundaries of the object; and
generating a modified image by performing an editing operation on the input image by editing at least a portion of the second set of pixels of the modified segment of the instance-aware trimap;
transmitting, for display via a user interface, the modified image

16. The non-transitory computer-readable medium of claim 15, the operations further comprising training the instance-aware image segmentation model, wherein training the instance-aware image segmentation comprises:
generating a training image by inserting a first object extracted from a first image into a second image depicting a second object;
applying the instance-aware segmentation model to the training image and a segmented image corresponding to the first image to generate a ground truth trimap;
generating a training segmented image by applying an image segmentation model to the training image;
generating a training instance-aware trimap by applying the instance-aware segmentation model to training input data comprising the training image and the training segmented image;
training the instance-aware image segmentation model by modifying one or more parameters of the instance-aware segmentation model based on comparing the training instance-aware trimap to the ground truth trimap,
wherein applying the instance-aware image segmentation model to the input data comprises applying the trained instance-aware image segmentation model to the input data.

17. The non-transitory computer-readable medium of claim 15, wherein the image editing operation comprises changing color values of one or more of the second set of pixels.

18. The non-transitory computer-readable medium of claim 15, wherein the image editing operation comprises applying an object removal model to the instance-aware trimap to replace color values of the second set of pixels with color values approximating a background of the input image.

19. The non-transitory computer-readable medium of claim 15, the operations further comprising generating, by the image editing system, the segmented image by applying an image segmentation model to the input image.

20. The non-transitory computer-readable medium of claim 15, wherein the instance-aware image segmentation model comprises a matting model, wherein the modified segment defines a boundary of a fibrous object in the input image.
